(19) United States
(12) Patent Application Publication
(10) Pub. No.: US 2025/0010382 A1
(43) Pub. Date: Jan. 9, 2025

(54) MILLING HEAD WITH THROUGH HOLE HAVING CENTERING AND DRIVE SURFACES AT TOOTH-RECEIVING LOBES, TOOL HOLDER AND ROTARY MILLING TOOL

(71) Applicant: ISCAR, LTD., TEFEN (IL)

(72) Inventor: MARTIN ULRICH ZETTLER, VAIHINGEN-HORRHEIM (DE)

(73) Assignee: ISCAR, LTD., TEFEN (IL)

(21) Appl. No.: 18/347,721

(22) Filed: Jul. 6, 2023

(51) Int. Cl. B23C 5/08; B23C 5/20

(52) U.S. Cl. CPC B23C 5/08; B23C 5/205

(57) ABSTRACT

A rotary milling tool has a tool holder and a milling head releasably attached thereto. The milling head has a head through recess opening out to the head forward and rearward surfaces. The recess includes a plurality of radially extending tooth-receiving lobes. The tool holder has a projection which includes a plurality of radially extending teeth. When assembled the teeth are located in the tooth-receiving lobes and provide centering and torque transfer capabilities.

### FIELD OF THE INVENTION

The subject matter of the present application relates to rotary milling tools having a milling head with a plurality of peripherally disposed cutting portions, and in particular to such a milling head having a through hole. The through hole has a plurality of driven surfaces for torque transfer from a tool holder and a plurality of radial centering surfaces for radial alignment of the milling head with said tool holder.

### BACKGROUND OF THE INVENTION

Rotary milling tools can include a milling head releasably clamped to a tool holder by at least one fastening member, e.g., a retaining screw. The milling head can have a plurality of peripherally disposed cutting portions. The milling head can have a through hole for engaging with a projection for providing radial centering of the milling head with respect to the tool holder. Typically, the through hole is cylindrical. The milling head can have a keyway extending radially outwardly from the through hole for receiving a key which provides torque transfer from the tool holder to the milling head.

A variety of such cutting tools and milling heads are disclosed in JP2021094680 A, DE202017105606 U1 and U.S. Pat. No. 7,153,068.

It is an object of the subject matter of the present application to provide an improved and compact engagement between a milling head a tool holder.

### SUMMARY OF THE INVENTION

In accordance with a first aspect of the subject matter of the present application there is provided a milling head having a head central axis that defines opposite forward and rearward directions and about which the milling head is rotatable in a rotational direction (R), the milling head comprising:
opposing head forward and rearward surfaces and a head peripheral surface extending therebetween, the head peripheral surface extending circumferentially about the head central axis;
a plurality of angularly spaced apart peripherally disposed cutting portions; and
a head through recess extending along the head central axis and opening out to the head forward and rearward surfaces, the head through recess being delimited circumferentially by a recess peripheral surface and comprising a plurality of angularly spaced apart tooth-receiving lobes extending radially outwardly; wherein:
   the recess peripheral surface comprises a plurality of driven surfaces and a plurality of radial centering surfaces, all being located at the plurality of tooth-receiving lobes and configured to abut corresponding surfaces on a tool holder, each driven surface facing opposite the rotational direction and each radial centering surface facing radially inwardly; and
   the plurality of radial centering surfaces are located radially outwards from the plurality of driven surfaces.

In accordance with a second aspect of the subject matter of the present application there is provided a tool holder, having a holder central axis that defines opposite forward and rearward directions and about which the tool holder is rotatable in the rotational direction, the tool holder comprising:
a shank peripheral surface which extends circumferentially about the holder central axis;
a shank forward end surface bounded by the shank peripheral surface located at a forward end of the tool holder; and
a shank projection projecting from the shank forward end surface along the holder central axis, the shank projection being delimited circumferentially by a projection peripheral surface and comprising a plurality of angularly spaced apart centering drive teeth extending radially outwardly; wherein:
   the projection peripheral surface comprises a plurality of driving surfaces and a plurality of radial alignment surfaces, all being located at the plurality of centering drive teeth and configured to abut corresponding surfaces on a milling head, each driving surface facing the rotational direction and each radial alignment surface facing radially outwardly; and
the plurality of radial alignment surfaces are located radially outwards from the plurality of driving surfaces.

In accordance with a third aspect of the subject matter of the present application there is provided a rotary milling tool, comprising:
a milling head of the type described above; and
a tool holder of the type described above;
wherein:
the milling head is releasably attached to the tool holder;
the shank projection is located in the head through recess;
the plurality of radial centering surfaces directly abut the plurality of radial alignment surfaces of the coupling portion; and
   the plurality of driven surfaces directly abut the plurality of driving surfaces.

It is understood that the above-said is a summary, and that features described hereinafter may be applicable in any combination to the subject matter of the present application, for example, any of the following features may be applicable to the milling head, tool holder or the rotary milling tool:

The recess peripheral surface can be oriented parallel to the head central axis.

The radial centering surface subtends a centering surface angle at the head central axis. The centering surface angle can be greater than or equal to 20° and less than or equal to 40°.

The head through recess can comprise a plurality of angularly spaced apart radial recess narrowings, circumferentially alternating with the tooth-receiving lobes along the recess peripheral surface. The recess peripheral surface can comprise a plurality of recess clearance surfaces, each recess clearance surface being located at a respective radial recess narrowing and facing radially inwardly.

The plurality of recess clearance surfaces can be convexly shaped.

The plurality of radial centering surfaces can be concavely shaped.

The plurality of radial centering surfaces can define an imaginary recess outermost cylinder centered at the head central axis.

The plurality of radial centering surfaces can lie on an internal surface of the imaginary recess outermost cylinder.

The plurality of recess clearance surfaces can define an imaginary recess innermost cylinder co-axial with the imaginary recess outermost cylinder. The imaginary recess innermost cylinder has a recess innermost cylinder radius. The imaginary recess outermost cylinder has a recess outermost cylinder radius. The recess innermost cylinder radius can be less than or equal to 75% of the recess outermost cylinder radius.

The milling head can comprise a plurality of angularly spaced apart fastening through holes, opening out to the head forward and rearward surfaces and spaced apart from the head through recess. Each fastening through hole can be located between two angularly adjacent tooth-receiving lobes of the head through recess.

The plurality of fastening through holes can be located inside, or intersected by, the imaginary recess outermost cylinder.

Each fastening through hole extends along a respective fastening through hole axis. The fastening through hole axes can be located inside the imaginary recess outermost cylinder.

The recess peripheral surface has a recess height, as measured in the axial direction. The plurality of radial centering surfaces and the plurality of driven surfaces can extend the full recess height.

The head through recess can comprise exactly three tooth-receiving lobes.

Every tooth-receiving lobe can have exactly one driven surface and exactly one radial centering surface located thereat.

The milling head can comprise a plurality of angularly spaced apart chip gullets which circumferentially alternate with the plurality of cutting portions along the head peripheral surface, each chip gullet opening out to at least one of the head forward surface and the head rearward surface. Each cutting portion can comprise an insert receiving pocket.

The head rearward surface can comprise at least one rearwardly facing planar axial bearing surface which extends along an entire angular extent thereof.

Each tooth-receiving lobe can comprise a lobe narrowing and a lobe widening located radially outward of the lobe narrowing. The lobe widenings have a maximum first width and the lobe narrowings have a maximum second width. The maximum first width can be greater than the maximum second width.

The head through recess can comprise a central region connecting to the plurality of tooth-receiving lobes. The radial length of each tooth-receiving lobe from the central region can exceed the radial extent of the central region.

The projection peripheral surface can be oriented parallel to the holder longitudinal axis.

Each radial alignment surface can subtend an alignment surface angle at the holder longitudinal axis. The alignment surface angle can be greater than or equal to 20° and less than or equal to 40°.

The shank projection can comprise a plurality of angularly spaced apart radial projection narrowings, circumferentially alternating with the centering drive teeth along the projection peripheral surface. The projection peripheral surface can comprise a plurality of projection clearance surfaces, each projection clearance surface being located at a respective radial projection narrowing and facing radially outwardly.

The plurality of projection clearance surfaces can be concavely shaped.

The radial alignment surfaces can be convexly shaped.

The radial alignment surfaces can define an imaginary projection outermost cylinder centered at the holder central axis.

The radial alignment surfaces can lie on an external surface of the imaginary projection outermost cylinder.

The plurality of projection clearance surfaces can define an imaginary projection innermost cylinder co-axial with the imaginary projection outermost cylinder. The imaginary projection innermost cylinder has a projection innermost cylinder radius. The imaginary projection outermost cylinder has a projection outermost cylinder radius. The projection innermost cylinder radius can be less than or equal to 75% of the projection outermost cylinder radius.

The tool holder can comprise a plurality of angularly spaced apart threaded bores, opening out to the shank forward end surface and spaced apart from the shank projection. Each threaded bore can be located between two angularly adjacent centering drive teeth.

The plurality of threaded bores can be located inside, or intersected by, the imaginary projection outermost cylinder.

Each threaded bore extends along a respective threaded bore axis. The threaded bore axes can be located inside the imaginary projection outermost cylinder.

The projection peripheral surface has a projection height, as measured in the axial direction. The plurality of radial alignment surfaces and the plurality of driving surfaces can extend the full projection height.

The shank projection can comprise exactly three centering drive teeth.

Every centering drive tooth can have exactly one driving surface and exactly one radial alignment surface located thereat.

The shank forward end surface can comprise at least one forwardly facing planar axial support surface which extends along an entire angular extent thereof.

The at least one axial bearing surface can abut the at least one axial support surface.

The milling head can be releasably clamped to the tool holder by a plurality of threaded fastening members, each threaded fastening member being located in a respective fastening through hole and threadingly engaged with a respective threaded bore.

### BRIEF DESCRIPTION OF THE FIGURES

For a better understanding of the present application and to show how the same may be carried out in practice, reference will now be made to the accompanying drawings, in which:

FIG. 1 is a perspective view of a rotary milling tool, in accordance with the present application;

FIG. 2 is an exploded perspective view of the rotary milling tool shown in FIG. 1;

FIG. 3 is a forward end view of the milling head shown in FIG. 1, showing five hidden head coolant channels;

FIG. 4 is a rearward end view of the milling head shown in FIG. 3, showing five hidden head coolant channels;

FIG. 4a is a detail of FIG. 4;

FIG. 5 is a side view of the milling head shown in FIG. 3;

FIG. 6 is a perspective view of a forward end of a tool holder, in accordance with the present application;

FIG. 7 is a forward end view of the tool holder shown in FIG. 6;

FIG. 8 is a side view of a forward end of the tool holder shown in FIG. 6, showing three hidden holder coolant channels opening out to a hidden radial relief recess;

FIG. 9 is a forward end view of the rotary milling tool shown in FIG. 1;

FIG. 10 is a side view of the forward end of the rotary milling tool shown in FIG. 1;

FIG. 11 is an axial cross-sectional view of the rotary milling tool shown in FIG. 9, taken along line X-X;

FIG. 12 is a radial cross-sectional view of the rotary milling tool shown in FIG. 10, taken along line Y-Y; and

FIG. 13 is a radial cross-sectional view of the rotary milling tool shown in FIG. 10, taken along line Z-Z.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

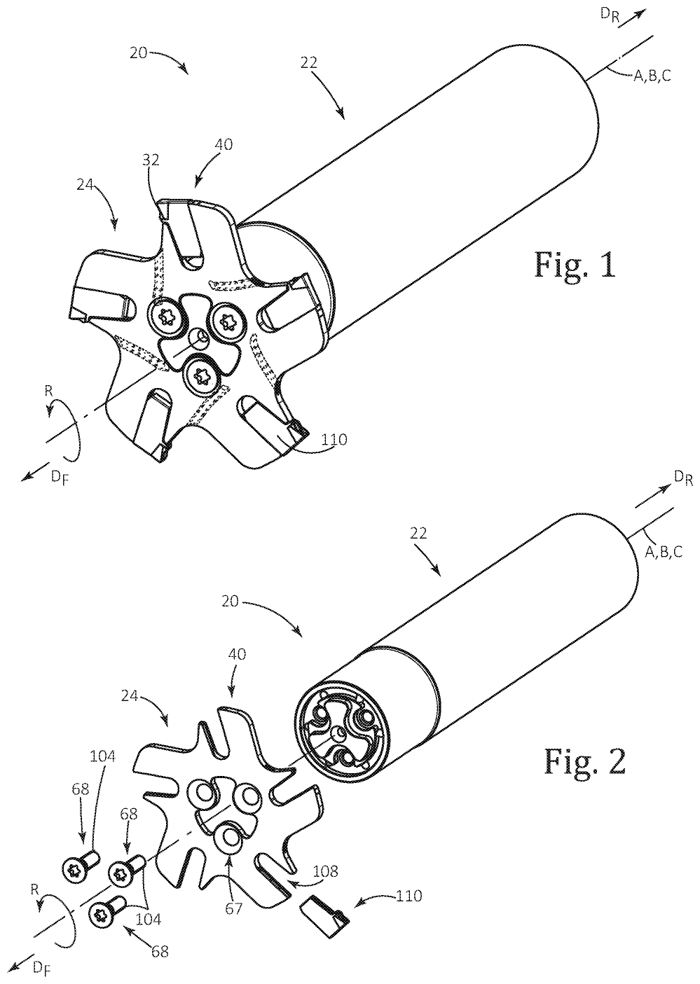

Attention is first drawn to FIGS. 1 and 2, showing a rotary milling tool 20, depicting an aspect of the present application. In this non-limiting example shown in the drawings, the rotary milling tool 20 can form a slitting saw suitable for slitting cutting operations. The rotary milling tool 20 has a tool central axis A. The rotary milling tool 20 has a tool holder 22 which can be typically made from steel. The rotary milling tool 20 has a milling head 24 which can be typically made from steel. The milling head 24 is releasably attached to the tool holder 22.

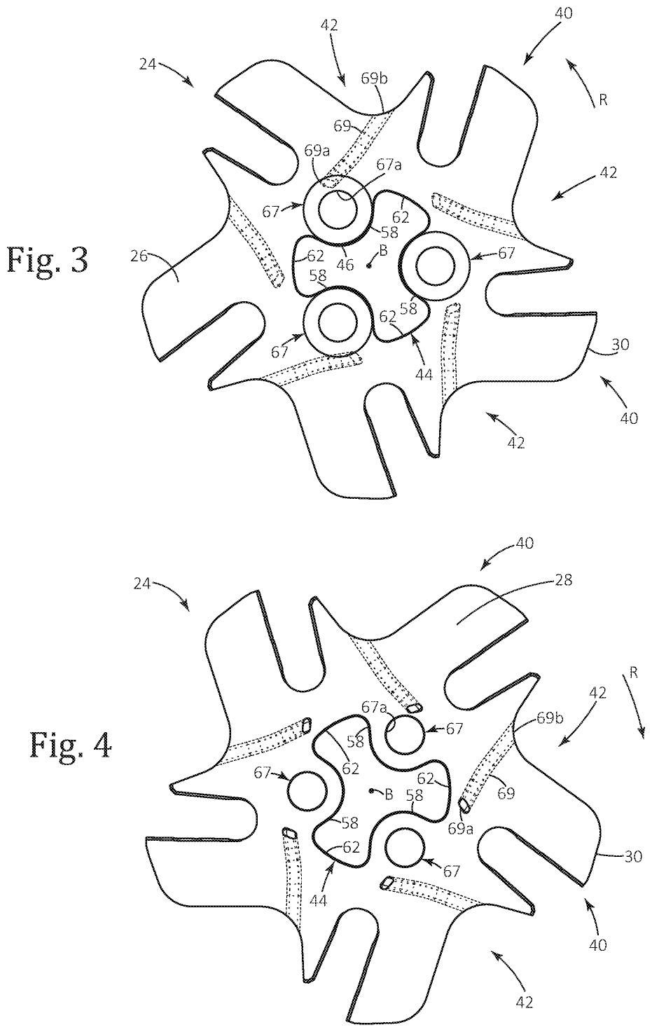

Reference is now made also to FIGS. 3 to 5, showing another aspect of the subject matter of the present application, relating to the milling head 24. The milling head 24 has a head central axis B. The head central axis B defines opposite forward and rearward directions D_{F}, D_{R}. The head central axis B forms an axis of rotation about which the milling head 24 is rotatable in a rotational direction R, where the rotational direction R is the cutting direction.

It should be appreciated that in the following discussion with regard to the milling head 24 use of the terms “forward” and “rearward” throughout the description and claims refer to a relative position in a direction of the head central axis B to the left (or rearward direction D_{R}) and to the right (or forward directions D_{F}), respectively, in FIG. 5. Moreover, the terms “axial” and “radial” are with respect to the head central axis B, unless specified otherwise.

The blank from which the milling head 24 is made can be additively manufactured. It should be noted that use of the term “additively manufactured” throughout the description and claims refers to refers to a type of component formed using one or more additive manufacturing processes used to create a three-dimensional object in which layers of material are formed to create an object. Examples of such additive manufacturing processes include, but are not limited to, Selective Laser Melting (SLM), Selective Laser Sintering (SLS), Direct Metal Laser Sintering (DMLS), Fused Deposition Modeling (FDM) and 3D Printing.

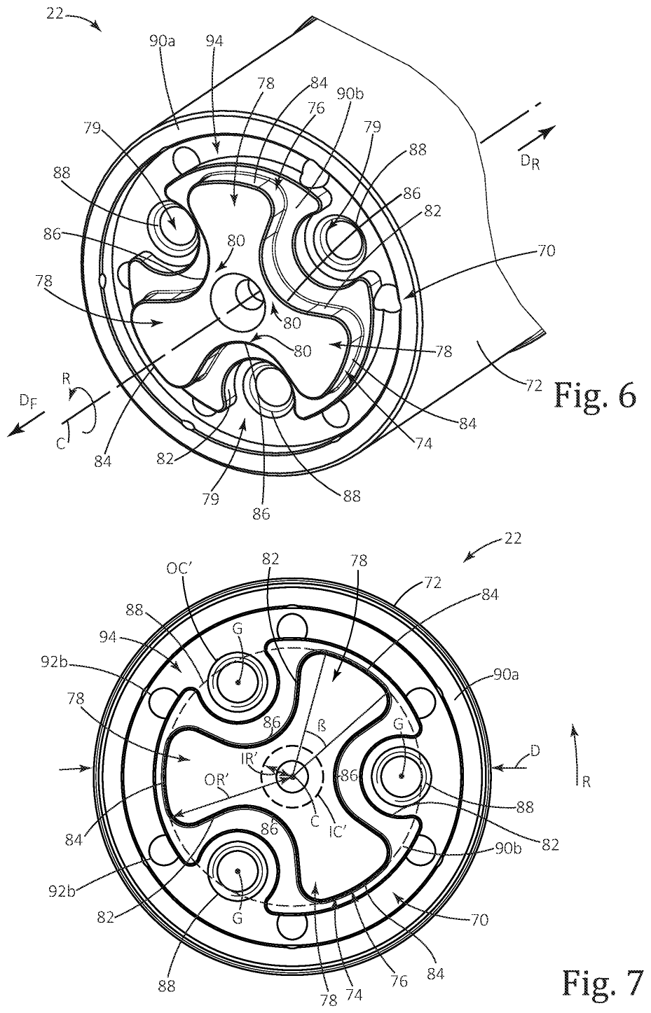

As shown in FIGS. 3 to 5, the milling head 24 includes opposing head forward and rearward surfaces 26, 28 and a head peripheral surface 30 which extends therebetween. The head forward surface 26 is axially forward of the head rearward surface 28. The head peripheral surface 30 extends circumferentially about the head central axis B. Generally speaking, the head peripheral surface 30 faces radially outwardly. In accordance with some embodiments of the subject matter of the present application, as shown in FIG. 6, the milling head 24 can be shorter in the axial direction than in the radial direction. The head forward and rearward surfaces 26, 28 can be parallel to each other and oriented perpendicular to the head central axis B. The milling head 24 can have a disc-like basic shape defined by the head forward and rearward surfaces 26, 28 and the head peripheral surface 30.

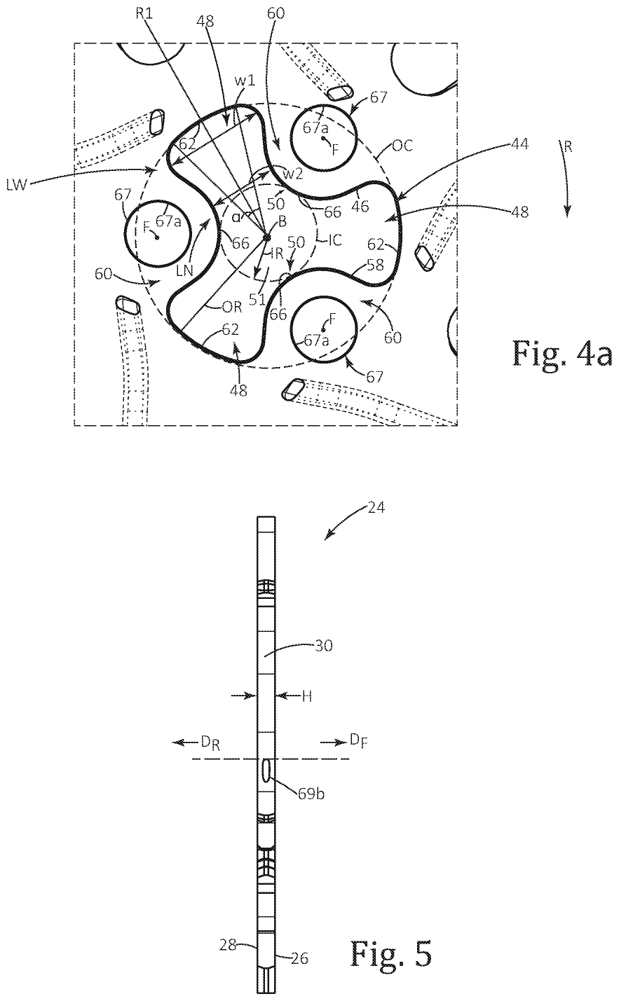

Referring to FIGS. 3 and 4, the milling head 24 includes a plurality of angularly spaced apart cutting portions 40 which extend radially outwardly. In accordance with some embodiments of the subject matter of the present application, each cutting portion 40 can include an insert receiving pocket 108, for seating of a cutting insert 110. The cutting insert 110 includes a cutting edge 32. The milling head 24 can include a plurality of angularly spaced apart chip gullets 42, for chip evacuation. The plurality of chip gullets 42 are recessed in the head peripheral surface 30 (radially inwardly) and circumferentially alternate with the plurality of cutting portions 40 along the head peripheral surface 30. In accordance with some embodiments of the subject matter of the present application, each chip gullet 42 can open out to both the head forward surface 26 and the head rearward surface 28.

The milling head 24 includes a head through recess 44 which opens out to the head forward and rearward surfaces 26, 28. The head through recess 44 extends along the head central axis B and is thus centrally disposed. Stated differently, the head central axis B passes through the head through recess 44. The head through recess 44 is delimited circumferentially by a recess peripheral surface 46. The recess peripheral surface 46 extends circumferentially about the head central axis B. Generally speaking, the recess peripheral surface 46 faces radially inwardly. In accordance with some embodiments of the subject matter of the present application, the recess peripheral surface 46 can be oriented parallel to the head central axis B. Referring to FIG. 5, the recess peripheral surface 46 can have a recess height H, as measured in the axial direction (i.e., along the head central axis B). The recess height H can be constant along the recess peripheral surface 46. The recess height H can be the same as the axial thickness of the milling head 24.

Referring to FIGS. 3, 4 and 4a, the milling head 24 includes a plurality of angularly spaced apart drive projections 60 extending radially inwardly into the head through recess 44. Thus, the head through recess 44 is non-cylindrical. Specifically, the head through recess 44 comprises a central region 51 connecting to a plurality of angularly spaced apart tooth-receiving lobes 48. Each drive projection 60 is located between two adjacent tooth-receiving lobes 48. The tooth-receiving lobes 48 extend radially outwardly. Each tooth-receiving lobe 48 includes a lobe narrowing LN and a lobe widening LW located radially outward of the lobe narrowing LN. Thus, each tooth-receiving lobe 48 may have a non-rectangular shape, such as a pear-shape. By virtue of the drive projections 60, the head through recess 44 includes a plurality of angularly spaced apart radial recess narrowings 50. The tooth-receiving lobes 48 are designed to receive a drive tooth as described later in the description. The plurality of radial recess narrowings 50 circumferentially alternate with the tooth-receiving lobes 48 along the recess peripheral surface 46. The recess peripheral surface 46 is further from the head central axis B at the tooth-receiving lobes 48 than at the radial recess narrowings 50. In this non-limiting example shown in the drawings, the milling head 24 includes exactly three drive projections 60 (though other numbers of drive projections 60 are also contemplated). Thus, the head through recess 44 includes exactly three tooth-receiving lobes 48 and exactly three radial recess narrowings 50. The plurality of drive projections 60 and the plurality of tooth-receiving lobes 48 can be identical, respectively.

The recess peripheral surface 46 includes a plurality of driven surfaces 58, each associated with a respective tooth-receiving lobe 48. The plurality of driven surfaces 58 are configured for torque transfer by directly abutting a corresponding surface on the tool holder 22. The plurality of driven surfaces 58 can be planar. Each driven surface 58 faces opposite the rotational direction R. Each driven surface 58 is located at a respective tooth-receiving lobes 48. Preferably, every tooth-receiving lobe 48 has exactly one driven surface 58 located thereat.

The recess peripheral surface 46 includes a plurality of radial centering surfaces 62, each associated with a respective tooth-receiving lobe 48. The plurality of radial centering surfaces 62 are designed to center the milling head 24 with respect to the tool holder 22 so that the two parts are co-axial when assembled. Each radial centering surface 62 faces radially inwardly. Each radial centering surface 62 is located at a respective tooth-receiving lobes 48. Preferably, every tooth-receiving lobe 48 has exactly one radial centering surface 62 located thereat.

The plurality of radial centering surfaces 62 can be concavely shaped. It is understood that the term “convexly/concavely shaped” as used throughout the description and claims includes a surface which is continuously (i.e., smoothly) convexly/concavely curved or alternatively consists of a plurality of straight sub-surfaces which provide the surface with a convex/concave shape. Preferably the plurality of radial centering surfaces 62 can be continuously concavely curved.

Referring to FIG. 4a, in accordance with some embodiments of the subject matter of the present application, the plurality of radial centering surfaces 62 can define an imaginary recess outermost cylinder OC centered at the head central axis B. The imaginary recess outermost cylinder OC can be a circumscribed cylinder. The plurality of radial centering surfaces 62 can lie on an internal surface of the imaginary recess outermost cylinder OC. The imaginary recess outermost cylinder OC delimits the plurality of tooth-receiving lobes 48 in the radially outward direction. Similarly, the imaginary recess outermost cylinder OC can define a boundary of the plurality of projections 60 in the radially outward direction. The imaginary recess outermost cylinder OC has a recess outermost cylinder radius OR.

In accordance with some embodiments of the subject matter of the present application, the radial centering surface 62 can subtend a centering surface angle α at the head central axis B. The centering surface angle α can fulfil the condition: 200≤α≤40°. Preferably, the centering surface angle α can fulfil the condition: 25°≤α≤35°.

In each tooth-receiving lobe 48, the lobe widening LW is circumferentially wider than the lobe narrowing LN. As seen in FIG. 4a, the lobe widenings LW have a maximum first width w1 while the lobe narrowings LN have a maximum second width w2, with w1>w2. Preferably, w1≥1.20*w2 (i.e., w1 is at least 20% longer than w2). Further preferably, w1≤1.80*w2 (i.e., w1 is at most 80% longer than w2). Here, the lobe widths w1 and w2 are shown to be measured in a direction perpendicular to a radial line R1 intersecting the head central axis B and bisecting the centering angle α, and are representative of the circumferential widths at the lobe widening LW and the lobe narrowing LN.

The plurality of radial centering surfaces 62 are located radially outwards from the plurality of driven surfaces 58. In accordance with some embodiments of the subject matter of the present application, the plurality of radial centering surfaces 62 and the plurality of driven surfaces 58 can extend the full recess height H.

In accordance with some embodiments of the subject matter of the present application, the recess peripheral surface 46 can include a plurality of recess clearance surfaces 66. Each recess clearance surface 66 can be located at a respective radial recess narrowing 50. Each recess clearance surface 66 can face radially inwardly. The plurality of recess clearance surfaces 66 can be convexly shaped. Preferably the plurality of recess clearance surfaces 66 can be continuously convexly curved. Further preferably, the plurality of recess clearance surfaces 66 can lie on internal surfaces of different imaginary cylinders (not shown) which are not centered head central axis B.

Referring to FIG. 4a, in accordance with some embodiments of the subject matter of the present application, the plurality of recess clearance surfaces 66 can define an imaginary recess innermost cylinder IC co-axial with the imaginary recess outermost cylinder OC. The imaginary recess innermost cylinder IC can be an inscribed cylinder. The plurality of recess clearance surfaces 66 can touch (but not extend across) the imaginary recess innermost cylinder IC. The imaginary recess innermost cylinder IC has a recess innermost cylinder radius IR. The recess innermost cylinder radius IR can be less than or equal to 75% of the recess outermost cylinder radius OR. Preferably, the recess innermost cylinder radius IR can be less than or equal to 50% of the recess outermost cylinder radius OR. The imaginary recess innermost cylinder IC has a recess innermost cylinder radius IR which may define the extent of the central region 51 of the head through recess 44. The plurality of drive projections 60 can terminate in the radially inward direction at the central region 51. And since recess outermost cylinder radius OR is larger than the recess innermost cylinder radius IR, the radial length of each tooth-receiving lobe 48 (from the central region 51) exceeds the radial extent of the central region 51 itself.

In accordance with some embodiments of the subject matter of the present application, the milling head 24 can include a plurality of fastening through holes 67 which open out to the head forward and rearward surfaces 26,28. The fastening through holes 67 are designed to receive a fastening member, for example a retaining screw, for attaching the milling head 24 to the tool holder 24. Preferably, the number of fastening through holes 67 matches the number of drive projections 60.

In accordance with some embodiments of the subject matter of the present application, the plurality of fastening through holes 67 can be angularly spaced apart about the head central axis B. The plurality of fastening through holes 67 can be spaced apart from the head through recess 44.

Each fastening through hole 67 extends along a respective fastening through hole axis F. In accordance with some embodiments of the subject matter of the present application, each fastening through hole 67 includes a fastening hole peripheral surface 67a which extends about the fastening through hole axis F. Each fastening through hole 67 can be rotationally symmetrical about its fastening through hole axis F. In particular, the fastening hole peripheral surface 67a can be cylindrical. In a view along the fastening through hole axis F, the fastening hole peripheral surface 67a can define the see-through part of the through fastening through hole 67. The fastening through hole 67 can open out to the head forward surface 26 via a chamfer to accommodate a screw head (see FIG. 3 vs FIG. 4).

Referring to FIG. 4a, each fastening through hole 67 can be located between two angularly adjacent tooth-receiving lobes 48 (of the head through recess 44). The plurality of fastening through holes 67 can be located inside, or intersected by, the imaginary recess outermost cylinder OC. Stated differently, the plurality of fastening through holes 67 may not be located outside the imaginary recess outermost cylinder OC. The fastening through hole axes F can be located inside the imaginary recess outermost cylinder OC. A majority of the fastening hole peripheral surface 67a of each fastening through hole 67 can be located on a respective drive projection 60.

As best seen in FIG. 11, in accordance with some embodiments of the subject matter of the present application, the head rearward surface 28 can include at least one rearwardly facing axial bearing surface 64a, 64b. The at least one axial bearing surface 64a, 64b is designed to locate the milling head 24 in a predetermined axial position with respect to the tool holder 22. The at least one axial bearing surface 64a, 64b can be planar and oriented perpendicularly to the head central axis B. The at least one axial bearing surface 64a, 64b can extend along an entire angular extent (i.e.,) 360° of the head rearward surface 28. In this non-limiting example shown in the drawings, the head rearward surface 28 can include first and second axial bearing surfaces 64a, 64b. The first and second axial bearing surfaces 64a, 64b are radially spaced apart, with the first axial bearing surface 64a being located radially outwards from the second axial bearing surface 64b. The first and second axial bearing surfaces 64a, 64b can be co-planar with each other.

Referring to FIGS. 3 and 4, in accordance with some embodiments of the subject matter of the present application, the milling head 24 can include a plurality of head coolant channels 69 (whose outline is indicated by broken lines), for directing coolant towards a cutting region. Each head coolant channel 69 has a head channel inlet 69a which can be located on the head rearward surface 28 and a head channel outlet 69b which can be located on the head peripheral surface 30. In this non-limiting example shown in the drawings, each head channel outlet 69b is located at a respective chip gullet 42.

Reference is now made to FIGS. 6 to 8, showing the tool holder 22, depicting a second aspect the present invention. The tool holder 22 has a holder central axis C. The tool holder 22 can be elongated along the holder central axis C. The holder central axis C extends in the forward and rearward directions D_{F}, D_{R}. The holder central axis C forms an axis of rotation about which the tool holder 22 is rotatable in the rotational direction R.

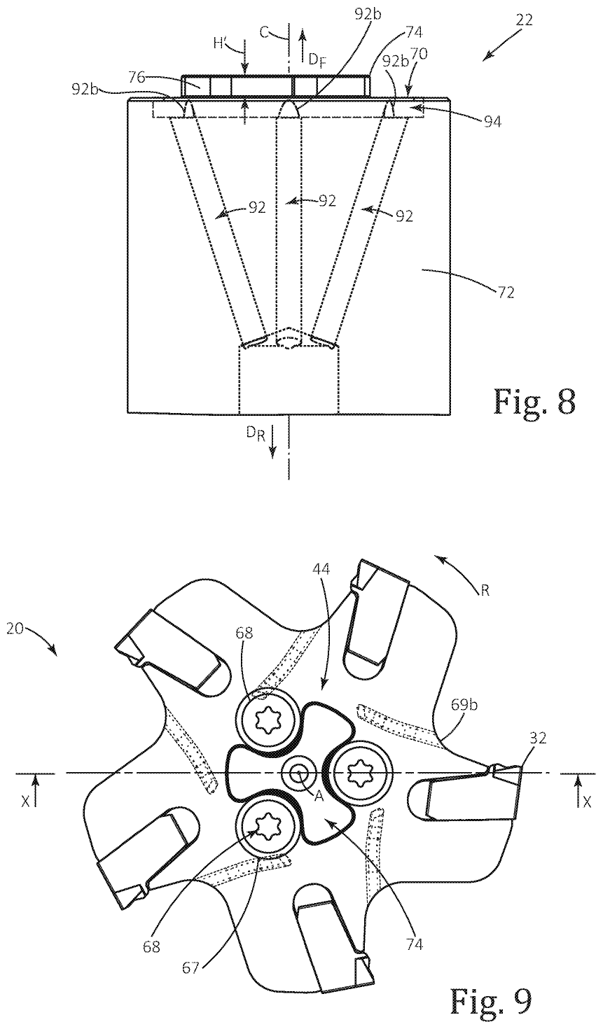

It should be appreciated that in the following discussion with regard to the tool holder 22, use of the terms “forward” and “rearward” throughout the description and claims refer to a relative position in a direction of the holder central axis C downwardly and upwardly, respectively, in FIG. 8. Moreover, the terms “axial” and “radial” are with respect to the holder central axis C, unless specified otherwise.

The tool holder 22 has a shank peripheral surface 72 which extends circumferentially about the holder central axis C. The tool holder includes a shank forward end surface 70 bounded by the shank peripheral surface 72. The shank peripheral surface 72 can be cylindrical and define a shank diameter D.

Referring to FIG. 6, the tool holder 22 includes a shank projection 74 which projects from the shank forward end surface 70 along the holder central axis C. The shank projection 74 is delimited circumferentially by a projection peripheral surface 76. The projection peripheral surface 76 extends circumferentially about the holder central axis C. Generally speaking, the projection peripheral surface 76 faces radially outwardly. In accordance with some embodiments of the subject matter of the present application, the projection peripheral surface 76 can be oriented parallel to the holder longitudinal axis C. The projection peripheral surface 76 can have a projection height H′, as measured in the axial direction (i.e., along the holder central axis C). The projection height H can be constant along the projection peripheral surface 76.

Making reference to FIG. 7, the shank projection 74 includes a plurality of angularly spaced apart centering drive teeth 78 which extend radially outwardly. The shank projection 74 also includes a plurality of angularly spaced apart radial projection narrowings 80, which circumferentially alternate with the centering drive teeth 78 along the projection peripheral surface 76. The projection peripheral surface 76 is further from the holder central axis C at the centering drive teeth 78 than at the radial projection narrowings 80. In this non-limiting example shown in the drawings, the shank projection 74 includes exactly three centering drive teeth 78 and exactly three radial projection narrowings 80. Adjacent pairs of centering drive teeth 78 can be spaced apart by a tooth gap 79. The plurality of centering drive teeth 78 can be identical.

The projection peripheral surface 76 includes a plurality of driving surfaces 82, for directly abutting the plurality of driven surfaces 58. When the tool holder 22 rotates about the holder central axis C torque is transferred to the milling head 24 via the driving surfaces 82. The plurality of driving surfaces 82 can be planar. Each driving surface 82 faces the rotational direction R. Each driving surface 82 is located at a respective centering drive tooth 78. Preferably, every centering drive tooth 78 has exactly one driving surface 82 located thereat.

The projection peripheral surface 76 includes a plurality of radial alignment surfaces 84, for directly abutting the plurality of radial centering surfaces 62. Each radial alignment surface 84 faces radially outwardly. Each radial alignment surface 84 is located at a respective centering drive tooth 78. Preferably, every centering drive tooth 78 has exactly one radial alignment surface 84 located thereat.

The plurality of radial alignment surfaces 84 can be convexly shaped. Preferably the plurality of radial alignment surfaces 84 can be continuously convexly curved.

Referring to FIG. 7, in accordance with some embodiments of the subject matter of the present application, the radial alignment surfaces 84 can define an imaginary projection outermost cylinder OC′ centered at the holder central axis C. The imaginary projection outermost cylinder OC′ can be a circumscribed cylinder. The plurality of radial alignment surfaces 84 can lie on an external surface of the imaginary projection outermost cylinder OC′. The imaginary projection outermost cylinder OC′ has a projection outermost cylinder radius OR′. The imaginary projection outermost cylinder OC′ delimits each tooth gap 79 in the radial outwards direction.

In accordance with some embodiments of the subject matter of the present application, each radial alignment surface 84 can subtend an alignment surface angle β at the holder longitudinal axis C. The alignment surface angle β can fulfil the condition: 20°≤β≤40°. Preferably, the alignment surface angle β can fulfil the condition: 25°≤β≤35°.

The plurality of radial alignment surfaces 84 are located radially outwards from the plurality of driving surfaces 82. In accordance with some embodiments of the subject matter of the present application, the plurality of radial alignment surfaces 84 and the plurality of driving surfaces 82 can extend the full projection height H′.

In accordance with some embodiments of the subject matter of the present application, the projection peripheral surface 76 can include a plurality of projection clearance surfaces 86. Each projection clearance surface 86 can be located at a respective radial projection narrowing 80. Each projection clearance surface 86 can face radially outwardly. The plurality of projection clearance surfaces 86 can be concavely shaped. Preferably the plurality of projection clearance surfaces 86 can be continuously concavely curved.

Referring again to FIG. 7, in accordance with some embodiments of the subject matter of the present application, the plurality of projection clearance surfaces 86 can define an imaginary projection innermost cylinder IC′ co-axial with the imaginary projection outermost cylinder OC′. The imaginary projection innermost cylinder IC′ can be an inscribed cylinder. The plurality of projection clearance surfaces 86 can touch (but not extend across) the imaginary projection innermost cylinder IC′. The imaginary projection outermost cylinder OC′ delimits the plurality of centering drive teeth 78 in the radially inward direction. The imaginary projection innermost cylinder IC′ has a projection innermost cylinder radius IR′. The projection innermost cylinder radius IR′ can be less than or equal to 75% of the projection outermost cylinder radius OR′. Preferably, the projection innermost cylinder radius IR′ can be less than or equal to 50% of the projection outermost cylinder radius OR′.

In accordance with some embodiments of the subject matter of the present application, the tool holder 22 can include a plurality of threaded bores 88 which open out to the shank forward end surface 70. The threaded bores 88 are for threadingly receiving the fastening members 68 as discussed hereinafter. Preferably, the number of threaded bores 88 matches the number of centering drive teeth 78.

Each threaded bore 88 extends along a respective threaded bore axis G. In accordance with some embodiments of the subject matter of the present application, the plurality of threaded bores 88 can be angularly spaced apart about the holder central axis C. The plurality of threaded bores 88 can be spaced apart from the shank projection 74.

Referring to FIG. 7, each threaded bore 88 can be located between two angularly adjacent centering drive teeth 78. The plurality of threaded bores 88 can be located inside, or intersected by, the imaginary projection outermost cylinder OC′. The threaded bore axes G can be located inside the imaginary projection outermost cylinder OC′. A majority of each threaded bore 88 can be located in a respective tooth gap 79. Advantageously, positioning the plurality of threaded bores 88 closer to the holder central axis C (for example, so that they are located at least partially in the tooth gaps 79) allows the shank diameter D to be reduced. Thus, for any specific tool diameter, the depth of cut of the slot can be increased.

As best seen in FIG. 11, in accordance with some embodiments of the subject matter of the present application, the shank forward end surface 70 can include at least one forwardly facing axial support surface 90a, 90b. The at least one axial support surface 90a, 90b can be planar and oriented perpendicularly to the holder central axis C. The at least one axial support surface 90a, 90b can extend along an entire angular extent (i.e.,) 360° of the shank forward end surface 70. In this non-limiting example shown in the drawings, the shank forward end surface 70 can include first and second axial support surfaces 90a, 90b. The first and second axial support surfaces 90a, 90b can be radially spaced apart by a radial relief recess 94 recessed in the shank forward end surface 70, with the first axial support surface 90a being located radially outward from the second axial bearing surface 90b. The radial relief recess 94 can be recessed along an entire angular extent (i.e.,) 360° of the shank forward end surface 70. The first and second axial support surfaces 90a, 90b can be co-planar with each other. The plurality of threaded bores 88 can open out in the radial relief recess 94. The second axial support surface 90b can surround the shank projection 74.

Referring to FIG. 8, in accordance with some embodiments of the subject matter of the present application, the tool holder 22 can include a plurality of holder coolant channels 92, for feeding coolant to the head coolant channels 69. Each holder coolant channel 92 has a holder coolant channel outlet 92b, for expelling coolant, which can be located on the shank forward end surface 70. In particular, the holder coolant channel outlet 92b can be located in the radial relief recess 94.

Referring to FIGS. 1 and 2, the milling head 24 is releasably clamped to the tool holder 22 by a plurality of fastening members 68 to form an assembled state of the rotary milling tool 20. In accordance with some embodiments of the subject matter of the present application, each fastening member 68 can be an integrally formed retaining screw having unitary one-piece (“monolithic”) construction with an external thread 104. That is to say, each fastening member 68 can be “threaded”.

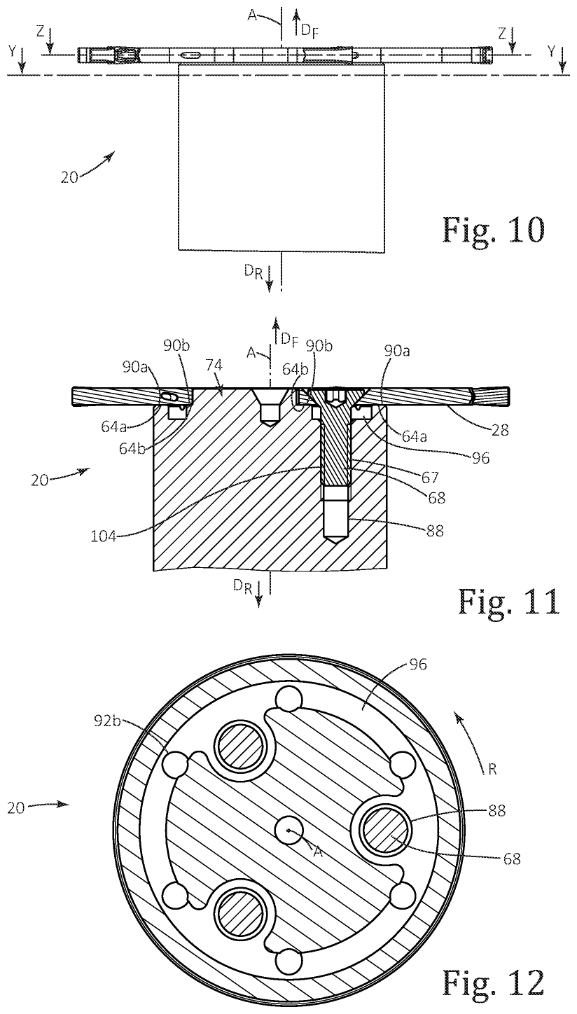

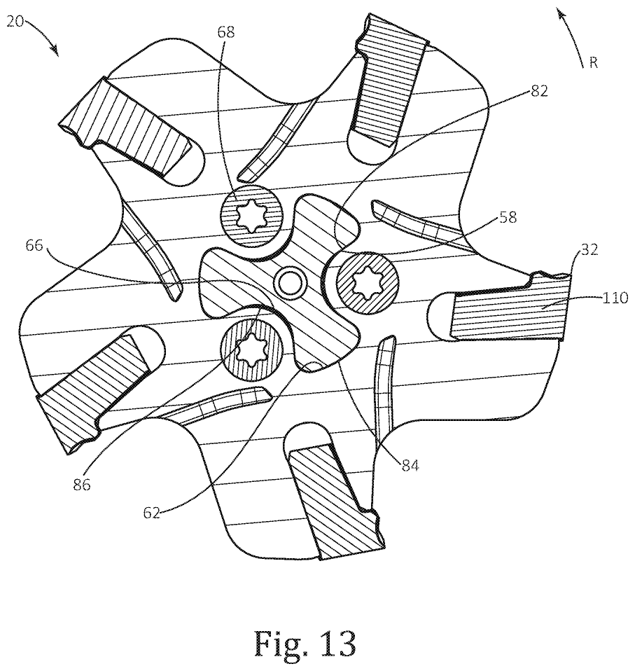

Reference is now made to FIGS. 9-13. In the assembled position of the rotary milling tool 20, the shank projection 74 is located in the head through recess 44. Each threaded fastening member 68 is located in a respective fastening through hole 67 and threadingly engaged with a respective threaded bore 88. The centering drive teeth 78 are located in the tooth-receiving lobes 48 of the milling head's head through recess 44. The plurality of driven surfaces 58 directly abut the plurality of driving surfaces 82. The plurality of radial centering surfaces 62 directly abut the plurality of radial alignment surfaces 84. In accordance with some embodiments of the subject matter of the present application, the at least one axial bearing surface 64a, 64b can abut the at least one axial support surface 90a, 90b. The plurality of recess clearance surfaces 66 may not abut the plurality of projection clearance surfaces 86.

Referring to FIGS. 11 and 12, in accordance with some embodiments of the subject matter of the present application, in the assembled position of the rotary milling tool 20, the radial relief recess 94 can be scaled by portions of the head rearward surface 28, thereby forming a coolant reservoir 96. In this non-limiting example shown in the drawings, the seal is formed by the abutment of the first and second axial bearing surfaces 64a, 64b with the first and second axial support surfaces 90a, 90b respectively. The head channel inlets 69a can be located on the head rearward surface 28 so that the head coolant channel 69 opens out into the coolant reservoir 96. The holder coolant channel 92 can be fed with a fluid coolant. Thus, the head channel inlets 69a can be in fluid communication with the holder channel outlet 92b via the coolant reservoir 96.

In the assembled position of the rotary milling tool 20, the milling head 24 and the tool holder 22 are co-axial. Stated differently, the head central axis B and the holder central axis C are co-incident with the tool central axis A.

Locating the fastening through holes 67 (at least partially) between the tooth-receiving lobes 48 and locating the threaded bores 88 (again, at least partially) between the drive teeth 78 results in a compact joint between the milling head 24 and the tool holder 22. This enables the aforementioned increase in the depth of cut of a slot, for any specific tool diameter.

It is noted that the milling head 24 shown in the figures does not require additional post-processing for forming a keyway (i.e., drive mechanism) adjoining the centering mechanism of the kind disclosed in EP 3153263A1, since the drive mechanism and the centering mechanism are formed together during the formation of the head through recess 44.

Although the subject matter of the present application has been described to a certain degree of particularity, it should be understood that various alterations and modifications could be made without departing from the spirit or scope of the invention as hereinafter claimed.

For example, the plurality of cutting edges 32 can be integrally formed with the milling head 24 to have unitary one-piece (“monolithic”) construction therewith.

What is claimed is:

1. A milling head (24) having a head central axis (B) that defines opposite forward and rearward directions (D_{F}, D_{R}) and about which the milling head (24) is rotatable in a rotational direction (R), the milling head (24) comprising:
opposing head forward and rearward surfaces (26, 28) and a head peripheral surface (30) extending therebetween, the head peripheral surface (30) extending circumferentially about the head central axis (B);
a plurality of angularly spaced apart peripherally disposed cutting portions (40); and
a head through recess (44) extending along the head central axis (B) and opening out to the head forward and rearward surfaces (26,28), the head through recess (44) being delimited circumferentially by a recess peripheral surface (46) and comprising a plurality of angularly spaced apart tooth-receiving lobes (48) extending radially outwardly; wherein:
the recess peripheral surface (46) comprises a plurality of driven surfaces (58) and a plurality of radial centering surfaces (62), all being located at the plurality of tooth-receiving lobes (48) and configured to abut corresponding surfaces on a tool holder (22), each driven surface (58) facing opposite the rotational direction (R) and each radial centering surface (62) facing radially inwardly; and
the plurality of radial centering surfaces (62) are located radially outwards from the plurality of driven surfaces (58).

2. The milling head (24), according to claim 1, wherein:
the recess peripheral surface (46) is oriented parallel to the head central axis (B).

3. The milling head (24), according to claim 1, wherein:
the radial centering surface (62) subtends a centering surface angle (α) at the head central axis (B); and
the centering surface angle (α) fulfils the condition: 20°≤α≤40°.

4. The milling head (24), according to claim 1, wherein:
the head through recess (44) comprises a plurality of angularly spaced apart radial recess narrowings (50), circumferentially alternating with the tooth-receiving lobes (48) along the recess peripheral surface (46); and
the recess peripheral surface (46) comprises a plurality of recess clearance surfaces (66), each recess clearance surface (66) being located at a respective radial recess narrowing (50) and facing radially inwardly.

5. The milling head (24), according to claim 4, wherein:
the plurality of recess clearance surfaces (66) are convexly shaped.

6. The milling head (24), according to claim 1, wherein:
the plurality of radial centering surfaces (62) are concavely shaped.

7. The milling head (24), according to claim 1, wherein:
the plurality of radial centering surfaces (62) define an imaginary recess outermost cylinder (OC) centered at the head central axis (B).

8. The milling head (24), according to claim 7, wherein:
the plurality of radial centering surfaces (62) lie on an internal surface of the imaginary recess outermost cylinder (OC).

9. The milling head (24), according to claim 7, wherein:
the head through recess (44) comprises a plurality of angularly spaced apart radial recess narrowings (50), circumferentially alternating with the tooth-receiving lobes (48) along the recess peripheral surface (46);
the recess peripheral surface (46) comprises a plurality of recess clearance surfaces (66), each recess clearance surface (66) being located at a respective radial recess narrowing (50) and facing radially inwardly;
the plurality of recess clearance surfaces (66) define an imaginary recess innermost cylinder (IC) co-axial with the imaginary recess outermost cylinder (OC);
the imaginary recess innermost cylinder (IC) has a recess innermost cylinder radius (IR);
the imaginary recess outermost cylinder (OC) has a recess outermost cylinder radius (OR); and
the recess innermost cylinder radius (IR) is less than or equal to 75% of the recess outermost cylinder radius (OR).

10. The milling head (24), according to claim 7, comprising:
a plurality of angularly spaced apart fastening through holes (67), opening out to the head forward and rearward surfaces (26,28) and spaced apart from the head through recess (44); wherein:
each fastening through hole (67) is located between two angularly adjacent tooth-receiving lobes (48) of the head through recess (44).

11. The milling head (24), according to claim 10, wherein:
the plurality of fastening through holes (67) are located inside, or intersected by, the imaginary recess outermost cylinder (OC).

12. The milling head (24), according to claim 10, wherein:
each fastening through hole (67) extends along a respective fastening through hole axis (F); and
the fastening through hole axes (F) are located inside the imaginary recess outermost cylinder (OC).

13. The milling head (24), according to claim 1, wherein:
the recess peripheral surface (46) has a recess height (H), as measured in the axial direction; and
the plurality of radial centering surfaces (62) and the plurality of driven surfaces (58) extend the full recess height (H).

14. The milling head (24), according to claim 1, wherein:
the head through recess (44) comprises exactly three tooth-receiving lobes (48).

15. The milling head (24), according to claim 1, wherein:
every tooth-receiving lobe (48) has exactly one driven surface (58) and exactly one radial centering surface (62) located thereat.

16. The milling head (24), according to claim 1, comprising:
a plurality of angularly spaced apart chip gullets (42) which circumferentially alternate with the plurality of cutting portions (40) along the head peripheral surface (30), each chip gullet (42) opening out to at least one of the head forward surface (26) and the head rearward surface (28); and
each cutting portion (40) comprises an insert receiving pocket (108).

17. The milling head (24), according to claim 1, wherein the head rearward surface (28) comprises at least one rearwardly facing planar axial bearing surface (64a, 64b) which extends along an entire angular extent thereof.

18. The milling head (24), according to claim 1, wherein:
each tooth-receiving lobe (48) comprises a lobe narrowing (LN) and a lobe widening (LW) located radially outward of the lobe narrowing (LN);
the lobe widenings (LW) have a maximum first width (w1) and the lobe narrowings (LN) have a maximum second width (w2); and
the maximum first width (w1) is greater than the maximum second width (w2).

19. The milling head (24), according to claim 1, wherein:
the head through recess (44) comprises a central region (51) connecting to the plurality of tooth-receiving lobes (48);
the radial length of each tooth-receiving lobe (48) from the central region (51) exceeds the radial extent of the central region (51).

20. A tool holder (22), having a holder central axis (C) that defines opposite forward and rearward directions (D_{F}, D_{R}) and about which the tool holder (22) is rotatable in the rotational direction (R), the tool holder (22) comprising:
a shank peripheral surface (72) which extends circumferentially about the holder central axis (C);
a shank forward end surface (70) bounded by the shank peripheral surface (72) located at a forward end of the tool holder (22); and
a shank projection (74) projecting from the shank forward end surface (70) along the holder central axis (C), the shank projection (74) being delimited circumferentially by a projection peripheral surface (76) and comprising a plurality of angularly spaced apart centering drive teeth (78) extending radially outwardly; wherein:
the projection peripheral surface (76) comprises a plurality of driving surfaces (82) and a plurality of radial alignment surfaces (84), all being located at the plurality of centering drive teeth (78) and configured to abut corresponding surfaces on a milling head (24), each driving surface (82) facing the rotational direction (R) and each radial alignment surface (84) facing radially outwardly; and
the plurality of radial alignment surfaces (84) are located radially outwards from the plurality of driving surfaces (82).

21. The tool holder (22), according to claim 20, wherein:
the projection peripheral surface (76) is oriented parallel to the holder longitudinal axis (C).

22. The tool holder (22), according to claim 20, wherein:
each radial alignment surface (84) subtends an alignment surface angle (B) at the holder longitudinal axis (C); and
the alignment surface angle (B) fulfils the condition: 20°≤β≤40°.

23. The tool holder (22), according to claim 20, wherein:
the shank projection (74) comprises a plurality of angularly spaced apart radial projection narrowings (80), circumferentially alternating with the centering drive teeth (78) along the projection peripheral surface (76); and
the projection peripheral surface (76) comprises a plurality of projection clearance surfaces (86), each projection clearance surface (86) being located at a respective radial projection narrowing (80) and facing radially outwardly.

24. The tool holder (22), according to claim 23, wherein:
the plurality of projection clearance surfaces (86) are concavely shaped.

25. The tool holder (22), according to claim 20, wherein:
the radial alignment surfaces (84) are convexly shaped.

26. The tool holder (22), according to claim 25, wherein:
the radial alignment surfaces (84) define an imaginary projection outermost cylinder (OC′) centered at the holder central axis (C).

27. The tool holder (22), according to claim 26, wherein:
the radial alignment surfaces (84) lie on an external surface of the imaginary projection outermost cylinder (OC′).

28. The tool holder (22), according to claim 26, wherein:
the shank projection (74) comprises a plurality of angularly spaced apart radial projection narrowings (80), circumferentially alternating with the centering drive teeth (78) along the projection peripheral surface (76);
the projection peripheral surface (76) comprises a plurality of projection clearance surfaces (86), each projection clearance surface (86) being located at a respective radial projection narrowing (80) and facing radially outwardly;
the plurality of projection clearance surfaces (86) define an imaginary projection innermost cylinder (IC′) co-axial with the imaginary projection outermost cylinder (OC′);
the imaginary projection innermost cylinder (IC′) has a projection innermost cylinder radius (IR′);
the imaginary projection outermost cylinder (OC′) has a projection outermost cylinder radius (OR′); and
the projection innermost cylinder radius (IR′) is less than or equal to 75% of the projection outermost cylinder radius (OR′).

29. The tool holder (22), according to claim 26, comprising:
a plurality of angularly spaced apart threaded bores (88), opening out to the shank forward end surface (70) and spaced apart from the shank projection (74); wherein:
each threaded bore (88) is located between two angularly adjacent centering drive teeth (78).

30. The tool holder (22), according to claim 29, wherein:
the plurality of threaded bores (88) are located inside, or intersected by, the imaginary projection outermost cylinder (OC′).

31. The tool holder (22), according to claim 29, wherein:
each threaded bore (88) extends along a respective threaded bore axis (G); and
the threaded bore axes (G) are located inside the imaginary projection outermost cylinder (OC′).

32. The tool holder (22), according to claim 20, wherein:
the projection peripheral surface (76) has a projection height (H′), as measured in the axial direction; and
the plurality of radial alignment surfaces (84) and the plurality of driving surfaces (82) extend the full projection height (H′).

33. The tool holder (22), according to claim 20, wherein:
the shank projection (74) comprises exactly three centering drive teeth (78).

34. The tool holder (22), according to claim 20, wherein:
every centering drive tooth (78) has exactly one driving surface (82) and exactly one radial alignment surface (84) located thereat.

35. The tool holder (22), according to claim 20, wherein:
the shank forward end surface (70) comprises at least one forwardly facing planar axial support surface (90a, 90b) which extends along an entire angular extent thereof.

36. A rotary milling tool (20), comprising:
a milling head (24), in accordance with claim 1; and
a tool holder (22), in accordance with claim 20;
wherein:
the milling head (24) is releasably attached to the tool holder (22);
the shank projection (74) is located in the head through recess (44);
the plurality of radial centering surfaces (62) directly abut the plurality of radial alignment surfaces (84) of the coupling portion (74); and
the plurality of driven surfaces (58) directly abut the plurality of driving surfaces (82).

37. The rotary milling tool (20), according to claim 36, wherein:
the head rearward surface (28) comprises at least one rearwardly facing axial planar bearing surface (64a, 64b) which extends along an entire angular extent thereof;
the shank forward end surface (70) comprises at least one forwardly facing planar axial support surface (90a, 90b) which extends along an entire angular extent thereof; and
the at least one axial bearing surface (64a, 64b) abuts the at least one axial support surface (90a, 90b).

38. The rotary milling tool (20), according to claim 36, wherein:
the milling head (24) comprises a plurality of angularly spaced apart fastening through holes (67), opening out to the head forward and rearward surfaces (26, 28) and spaced apart from the centering drive through recess (44); and:
the tool holder (22) comprises a plurality of angularly spaced apart threaded bores (88), opening out to the shank forward end surface (70) and spaced apart from the shank projection (74); and
the milling head (24) is releasably clamped to the tool holder (22) by a plurality of threaded fastening members (68), each threaded fastening member (68) being located in a respective fastening through hole (67) and threadingly engaged with a respective threaded bore (88).
